(19) United States
(12) Patent Application Publication
(10) Pub. No.: US 2004/0221165 A1
(43) Pub. Date: Nov. 4, 2004

(54) Method for signing data

(76) Inventors: Thomas Birkhoelzer, Radolfzell (DE); Juergen Vaupel, Weisendorf (DE)

Correspondence Address: HARNESS, DICKEY & PIERCE, P.L.C., P.O. BOX 8910, RESTON, VA, 20195, US

(21) Appl. No.: 10/785,198

(22) Filed: Feb. 25, 2004

(30) Foreign Application Priority Data
Feb. 25, 2003 (DE) 10307995.5

(51) Int. Cl. H04L 9/00

(52) U.S. Cl. 713/182

(57) ABSTRACT

A method is for signing access operations to electronic data. A data processing facility is for carrying out the method. A first step of the method involves the performance of a security check in order to ascertain the identity of a user. A second step involves a user signature, which clearly identifies the user, being assigned on the basis of the result of the security check without being able to be viewed by the user. A third step involves a role signature, which can be assigned in parallel to a plurality of users having a common role affiliation, being assigned on the basis of the result of the security check without being able to be viewed by the user. A fourth step involves access operations to electronic data being signed by specifying both the user signature and the role signature. The multiple signature ensures that all data access operations can be subsequently reconstructed by specifying the user and the user's role affiliation at the time of the data access.

The present application hereby claims priority under 35 U.S.C. §119 on German patent application number DE 103 07 995.5 filed Feb. 25, 2003, the entire contents of which are hereby incorporated herein by reference.

### FIELD OF THE INVENTION

The invention generally relates to a method for the signing of data by various users. The invention also generally relates to a data processing facility for carrying out the method and to a storage medium which stores information for carrying out the method on a data processing facility.

### BACKGROUND OF THE INVENTION

The increasing use of electronic data and communication channels entails constantly growing demands on mechanisms allowing data access operations to be subsequently reconstructed. At the same time, however, the intention is to ensure that the data can be accessed as easily, conveniently and with as little complexity as possible. Particularly the increasing reciprocal networking and the frequently large number of different users who can gain electronic access to the same data have meant that effective electronic or software-based documentation mechanisms have become indispensable in order to prevent anonymous manipulation or viewing.

On account of the diverse access options and on account of the fact that electronic data access operations cannot readily be traced back to really existing people, it is necessary to store and hence to document all data access operations by specifying a signature for the accessing party. Data access operations by really existing users are documented by using a user-specific signature which is available exclusively to the respective user and whose use requires said user to authenticate himself.

Documenting access operations to electronic data plays a particularly important role in the case of person-related data, such as address lists or customer data, in the case of data in the financial sector and particularly in the case of data in the health sector. In the health sector, where the most stringent demands are placed on data integrity, data protection provisions demand that any user of data be clearly identified and authenticated. In this context, identification devices that every data access operation or every action is clearly linked to the executing user, that is to say a really existing person, and is documented with an electronic signature for this person in order to allow subsequent reconstruction. Authentication devices that a user's authentication is checked specifically and only authenticated users can actually be assigned a signature. In the health sector, the documentation function is also called “auditing” and the authentication function is also called “access control”.

Electronic data can be available to a plurality of different users. This may be the case, by way of example, when customer data are being managed by the employees of a bank, in the case of personal data in personnel departments, in the case of joint use of data in development teams or in the case of data in the health sector, which need to be accessible to teams of treating physicians or to a particular group of medical specialist personnel. If a plurality of users are intended to have joint use of the same data, then in this regard they are part of the same role. The common role affiliation is not reflected in the known, user-specific signatures. In this regard, the role affiliation cannot be depicted using conventional signatures and, if it is to be documented in order to allow subsequent reconstruction, needs to be specifically stored and archived in an appropriate manner. This complicates the storage measures required for “auditing” considerably. The subsequent reconstruction of data accessing operations and their association with role affiliates are also complicated as a result.

### SUMMARY OF THE INVENTION

An object of an embodiment of the invention is to simplify the use of electronic signatures and, at the same time, to ensure that various users' and various role affiliates' data access operations to jointly used electronic data can subsequently be reconstructed in full.

An embodiment of the invention achieves an object by a method, by a data processing facility and/or by a storage medium.

An important concept of an embodiment of the invention is that, prior to the signing of access operations to electronic data, first a security check is performed in order to ascertain the identity of a user. The user is assigned a unique user signature and additionally a role signature on the basis of the result of this security check. The role signature is able to be assigned to a plurality of different users. Data access operations are signed by specifying the user signature and additionally the role signature. Neither the user signature nor the role signature can be viewed by the user.

The signing of data access operations by specifying both the user signature and the role signature affords the advantage that a signature provides all the information for subsequent reconstruction of the identity and the role of a party accessing data at the time of the data access. In addition, the signatures are extremely well protected against manipulation, since they are assigned on the basis of a security check and cannot be viewed by the user, which means that he cannot misuse them. Another advantage is that the method requires just one security check from the user, but otherwise takes place fundamentally unnoticed by the users, and is therefore particularly easy and noncomplex to handle.

In one advantageous refinement of an embodiment of the invention, the security check is performed by biometric ascertainment of user data, such as detection of the form of the iris or of the fingerprint. This affords the advantage that a particularly high level of proof against deception is attained without requiring additional complexity for the user, such as memorizing a password.

In another advantageous refinement of an embodiment of the invention, the user signature is ascertained by checking a user signature memory which is arranged so as to be physically remote. This affords the advantage that the user signature memory can be maintained by way of administration provided specifically for that purpose and can be protected using particularly restrictive protective measures, e.g. firewalls, to which the user's workstation does not need to be subject. It is likewise possible for the role signature memory to be arranged so as to be physically remote, in order to attain the same advantages, in which case it can be arranged together with or separately from the user signature memory.

Another advantageous refinement of an embodiment of the invention is obtained by virtue of each user admittedly being able to be assigned just one user signature, but being able to be assigned a plurality of role signatures simultaneously. This reflects the actual role affiliations, since one user can be active, by way of example, in a plurality of functions or as a member of a plurality of teams which each represent separate roles. The possibility of being affiliated to a plurality of role signatures affords the advantage that the real role affiliations can be depicted completely by the signatures.

### BRIEF DESCRIPTION OF THE DRAWINGS

The present invention will become more fully understood from the detailed description of preferred embodiments given hereinbelow and the accompanying drawing, which is given by way of illustration only and thus are not limitative of the present invention, and wherein:

FIG. 1 shows a flowchart with the method steps required for implementing an embodiment of the invention,

FIG. 2 shows a system architecture which is suitable for implementing an embodiment of the invention.

### DETAILED DESCRIPTION OF THE PREFERRED EMBODIMENTS

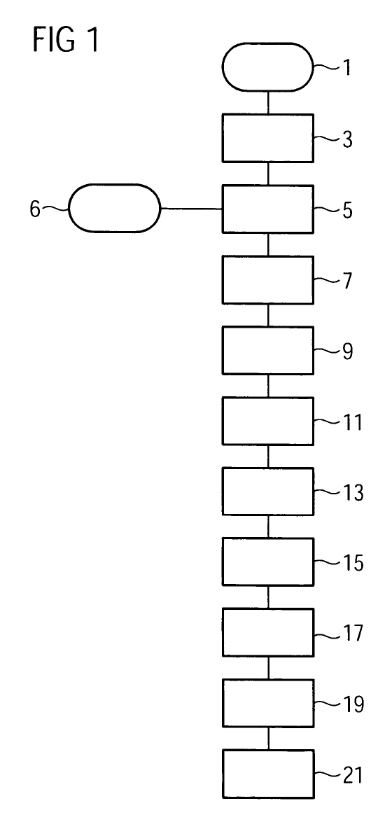

FIG. 1 shows the method steps required for implementing an embodiment of the invention.

In step 1, the data processing facility 50, which may be a medical computer workstation, for example, is started. This involves the usual starting of an operating system and logon thereto. The method for signing in accordance with an embodiment of the invention proceeds independently of such logon to the operating system, however.

In step 3, the signature tool 51 is started after the operating system has started up. The signature tool 51 does not need to be started whenever the operating system starts up, but measures have been taken to ensure that it is started prior to any data access to application data on the workstation. The application data, may be, by way of example, diagnostic photographs, medical findings, personality information for patients, or else research-related contents, demographic information of financial information. All of these examples involve critical data for which access needs to be documented in a particular manner.

In step 5, a security check is performed which is intended to identify a user. To this end, the user is asked for person-specific data which need to satisfy all demands on data integrity. Preferably, this is done by addressing a security check device 59 which biometrically detects the characteristic data which are as deception-proof as possible, such as a finger print or the form of the iris. It is also possible for the security check device 59 to read an electronic chip card or an electronic or mechanical key. The security check takes into account the demands on authentication.

In step 6, it is possible to abort the method when the security check has failed, in order to meet an increased requirement for data integrity.

In step 7, a user signature memory 61 is checked. The user signature memory 61 stores information which can identify a user as a really existing person using the data ascertained in the previous security check. By way of example, the user signature might be found in a tabular association between signatures and security check data, or in an association with really existing people identified as the result of the security check.

In step 9, a user signature is ascertained as the result of the previous check in the user signature memory 61. The degree of proof against deception for ascertaining the user signature is essentially dependent on the proof against deception of the previous security check and also on the manipulability of the user signature memory 61.

In step 11, the previously ascertained user signature is assigned to the current user and is immediately available for signing actions by the user. The assignment is made fundamentally unnoticed by the user, and in particular there is no kind of opportunity to view the signature. This firstly prevents the user from being bothered by information which is not important to him, and secondly the lack of knowledge prevents him from being able to misuse the signature.

In step 13, a role signature memory 63 is checked. The role signature memory 63 stores information which can be used to identify a “role” on the basis of the data ascertained in the previous security check. This could be done, by way of example, by accessing a tabular association between roles and security check data. Instead of an association with security check data, it would also be possible to use an association with user signatures or with really existing people identified as the result of the security check.

Role affiliation to a particular activity group with a particular responsibility, e.g. “practicing physician”, “medicotechnical assistant”, “administrative team”, “system administrator”, “personnel department” or “project manager”.

The role affiliation can be obtained either on an object-related basis, i.e. from the need for particular users to be able to work with a particular data stock, or on a subject-data related basis, i.e. from a hierarchic classification for the respective user which allows him to access data in a particular classification. In addition, a user may be affiliated to a plurality of roles representing, by way of example, different “administrative teams” in which the user is collaborating simultaneously. In such cases, the user could either be assigned a single role signature representing all role affiliations, or he could be assigned a plurality of role signatures simultaneously.

In step 15, a role or possibly a plurality of roles is/are ascertained as the result of the previous check in the role signature memory 63.

In step 17, one or possibly a plurality of affiliated role signatures is/are ascertained as the result of the ascertainment of one or more roles.

The split of the previous step 15 and 17 reflects a procedure for ascertaining roles and role signatures which first involves roles and role affiliations being defined on the basis of the requirements of the work environment and then involves electronic signatures being defined for these roles. However, steps 15 and 17 could also be integrated into a signal step by dispensing with the intermediate step of ascertaining one or more roles and instead ascertaining role signatures immediately.

In step 19, the previously ascertained role signature or the plurality of role signatures is/are assigned to the current user and is/are immediately available for signing actions by the user. The assignment is made, as explained above, fundamentally unnoticed by the user, and in particular he is provided with no kind of opportunity to view the signature.

In step 21, actions are signed both using the assigned user signature and using the assigned role signature(s). The multiple signing allows full subsequent reconstruction of all signed data access operations both in association with a really existing person and in association with said person's respective current role affiliation. This satisfies the demands on auditing data access operations without the need, by way of example, to check additional information, such as past service plans, for the purpose of subsequently reconstructing the former role affiliations of people.

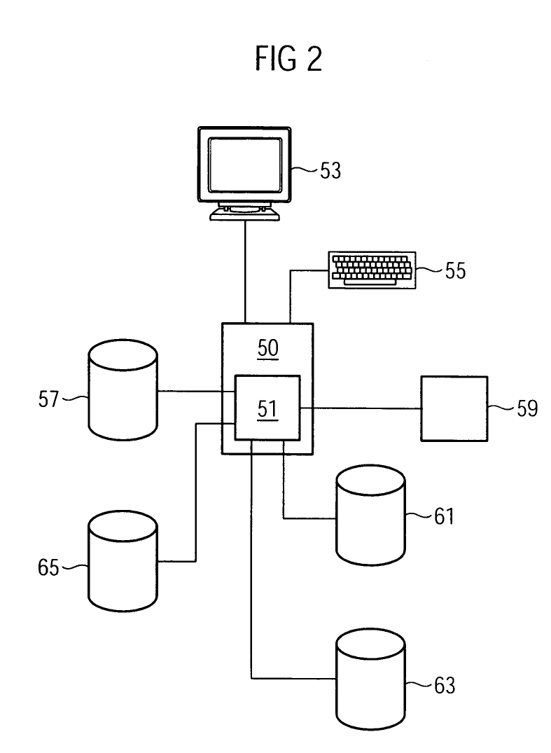

FIG. 2 shows an electronic data processing facility 50 which can carry out the method for implementing an embodiment of the invention. The data processing facility 50 has a keyboard 55 or other input unit and also a screen 53. Depending on the type of application, audible input and output signals can also be processed. The type and scope of the input and output units are of no significance to the implementation of an embodiment of the invention. The data processing facility 50 can either be a medical workstation, e.g. a “modality”, or any other workstation with a screen, e.g. a bank terminal.

The data processing facility 50 has a signature tool 51. The signature tool 51 may be able to be integrated in modular fashion into the data processing facility 50, e.g. in the form of a plug-in card or in the form of a computer program. The signature tool 51 provides the data processing facility 50 with access to an application data store 57 which is used for storing application data.

The signature tool 51 and the data processing facility 50 are designed such that the application data store 57 can be accessed exclusively using the signature tool 51. This ensures that any data access is documented and signed by the signature tool 51 without the possibility of a bypass. This makes manipulation or misuse as a result of bypassing the signing process largely impossible.

The signature tool 51 is connected to a security check device 59 which is used for ascertaining data for the purpose of identifying the respective user. The security check device 59 may be a chip card reader which reads a user-specific chip card. It may also be a mechanical or electronic lock which reads a user-specific key. Not least, it may be a sensor for ascertaining biometric data from the user, for example measuring the form of the user's iris, his fingerprints or his voice frequency range. The use of biometric data for the security check has the advantage that there is no need to use any kind of key or card which the user might lose or which might be stolen from him. In addition, biometric data's proof against deception can be esteemed higher than that of other key systems.

The signature tool 51 also has access to a user signature memory 61 which contains information for identifying users on the basis of the data ascertained by the security check means 59. This information allows a user signature to be ascertained, e.g. on the basis of tabular associations between security check data and signatures. In addition, the respective user can be identified as a really existing person on the basis of this information.

The signature tool 51 also has access to a role signature memory 63 which contains information for ascertaining one or more role signatures on the basis of the data ascertained by the security check device 59. This information allows a role signature to be ascertained, e.g. on the basis of tabular associations between role signatures and security check data, really existing people or user signatures.

For the signature memories 61, 63, particular security requirements apply which can make it appropriate for these memories to be set up centrally at a remote location. For this purpose, they can be positioned independently of the data processing facility 50 and of the signature tool 51 and might also be accessible using protected data telecommunication links, for example. The data telecommunication link may mean a cableless or cable-connected modem connection or else, by way of example, an Internet or intranet connection.

The independent positioning of the signature memories 61, 63 firstly allows them to be accessed by further, different data processing facilities or signature tools as well. Secondly, it allows relatively stringent security precautions to be put in place specifically for the signature memories 61, 63 as compared with the data processing facility 50, e.g. of a particularly restrictive firewall.

The use of two separate signature memories 61, 63 gives the signing system a modular structure with the greatest possible flexibility. This allows changes to be made in the signature memories 61, 63 largely independently of one another at any time. In the user signature memory 61, the security-critical information used for identifying the user can be changed on a regular basis, in a similar manner to when central trust centers are set up separately. In the role signature memory 63, changes to the role affiliation can be made which reflect alterations in the affiliation between real people and teams or responsibilities.

The signing system has been described above on the basis of the use of two different signature memories 61, 63. These two memories represent the logical associations between information which are made in the course of the signing method. First, the user or his user signature needs to be identified as the result of the security check, and secondly he needs to be assigned to a role, or a role signature needs to be ascertained.

Although the modular structure correctly represents the actual logical associations, it would naturally be possible to use a single, integrated signature memory instead, however. Depending on other requirements, this single signature memory could be arranged separately or could be integrated into the signature tool 51 or the data processing facility 50.

A fundamental factor, however, is that the security check by the security check device 59 allows no inference with regard to the signatures which are to be assigned, which are used for signing user actions. This is a guarantee that the signature used cannot be manipulated and is reliable.

The signature tool 51 documents any access to application data or to the application data store 57 by specifying the user signature and additionally the role signature. If a plurality of role signatures have been assigned, then these are also specified for documentation purposes. All signatures are stored by the signature tool 51 together with information about the accessed data and about the type of data access. This allows retrospective reconstruction at any time regarding who has accessed what data in what manner. In addition, the respective current role of the party accessing data can be established on the basis of the role signature or signatures without this necessitating that further information, e.g. archived service plans or presence lists, be fetched. In this case, the security check 5 ensures at all times that the signatures used for documentation are assigned correctly.

In addition, the user is provided with no way of viewing the signatures used by the signature tool 51. This largely prevents opportunities for misusing and manipulating the signature data. In addition, the user is no longer confronted by the assignment of the signatures, and finds the work of the signature tool 51 to be uncomplicated and easy to handle.

In principle, the data access operations are documented by the signature tool 51 together with the accessed application data in the application data store 57. In addition, there may be an audit memory 65 for separate documentation of all user actions. This affords the opportunity to store, by way of example, just the type of data access operations and also the signatures in the audit memory 65, but to dispense with storing the application data, which may be very extensive. Medical image data, in particular, frequently have a considerable storage volume which may necessitate removal to archive systems. In such cases, the separate audit memory 65 can be used to record application history for specific workstations so as to document not only access to the application data but also use of the respective workstation in a manner which can subsequently be reconstructed, but without the need to store all of the memory-intensive application data.

A storage medium is adapted to store information and adapted to interact with a data processing facility to perform the method of any of the above mentioned embodiments. The storage medium can be offered to the user in the form of a computer-readable storage medium. The storage medium may be a built-in medium installed inside a computer main body or removable medium arranged so that it can be separated from the computer main body. Examples of the built-in medium include, but are not limited to, rewriteable involatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable involatile memory, such as memory cards; and media with a built-in ROM, such as ROM cassettes.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for signing access operations to electronic data, comprising:
performing a security check in order to ascertain the identity of a user;
assigning a user signature, identifying the user, on the basis of the performed security check without being viewable by the user;
assigning a role signature, assignable to a plurality of users, on the basis of the performed security check without being viewable by the user; and
permitting an access operation to electronic data by specifying the user signature and the role signature.

2. The method as claimed in claim 1, wherein the security check involves biometric data from the user being ascertained.

3. The method as claimed in claim 1, wherein the security check involves reading at least one of an electronic and mechanical key.

4. The method as claimed in claim 1, wherein the user signature to be assigned is ascertainable on the basis of the data ascertained in the security check, by checking a user signature memory.

5. The method as claimed in claim 1, wherein the role signature to be assigned is ascertainable on the basis of the data ascertained in the security check, by checking a role signature memory.

6. The method as claimed in claim 4, wherein the user signature memory is checked using a data telecommunication link.

7. The method as claimed in claim 1, wherein one user is assignable a plurality of role signatures simultaneously.

8. The method as claimed in claim 1, wherein the data are medically relevant, wherein the users are medical specialist personnel, and wherein the roles are formed in line with the workgroups within the medical specialist personnel.

9. A data processing facility, comprising:
security check means for, prior to the data processing facility accessing application data, performing a security check in order to ascertain an identity of a user; and
a signature tool, adapted to assign a user signature, identifying the user, on the basis of an output signal from the security check means without being viewable by the user, wherein the signature tool is further adapted to assign a role signature, assignable to a plurality of users, on the basis of an output signal from the security check means without being viewable by the user, and wherein the signature tool is still further adapted to sign access operations to electronic data by specifying the user signature and the role signature.

10. The data processing facility as claimed in claim 9, wherein the security check means is further for ascertaining biometric data from the user.

11. The data processing facility as claimed in claim 9, wherein the security check means is adapted to read at least one of electronic and mechanical keys.

12. The data processing facility as claimed in claim 9, wherein the signature tool has access to a user signature memory and is adapted to check the user signature memory, on the basis of an output signal from the security check means, for the user signature which is to be assigned.

13. The data processing facility as claimed in claim 9, wherein the signature tool has access to a role signature memory and is adapted to check the role signature memory, on the basis of an output signal from the security check means, for the role signature which is to be assigned.

14. The data processing facility as claimed in claim 12, wherein the user signature memory is arranged remotely from the data processing facility, and wherein the signature tool has access thereto via a data telecommunication link.

15. The data processing facility as claimed in claim 9, wherein the data processing facility is a medical workstation.

16. A storage medium, adapted to store information and adapted to interact with a data processing facility to perform the method as claimed in claim 1.

17. The method as claimed in claim 2, wherein the security check involves reading at least one of an electronic and mechanical key.

18. The method as claimed in claim 2, wherein the user signature to be assigned is ascertainable on the basis of the data ascertained in the security check, by checking a user signature memory.

19. The method as claimed in claim 3, wherein the user signature to be assigned is ascertainable on the basis of the data ascertained in the security check, by checking a user signature memory.

20. The method as claimed in claim 2, wherein the role signature to be assigned is ascertainable on the basis of the data ascertained in the security check, by checking a role signature memory.

21. The method as claimed in claim 3, wherein the role signature to be assigned is ascertainable on the basis of the data ascertained in the security check, by checking a role signature memory.

22. The method as claimed in claim 5, wherein the role signature memory is checked using a data telecommunication link.

23. The data processing facility as claimed in claim 10, wherein the security check means is adapted to read at least one of electronic and mechanical keys.

24. The data processing facility as claimed in claim 10, wherein the signature tool has access to a user signature memory and is adapted to check the user signature memory, on the basis of an output signal from the security check means, for the user signature which is to be assigned.

25. The data processing facility as claimed in claim 11, wherein the signature tool has access to a user signature memory and is adapted to check the user signature memory, on the basis of an output signal from the security check means, for the user signature which is to be assigned.

26. The data processing facility as claimed in claim 10, wherein the signature tool has access to a role signature memory and is adapted to check the role signature memory, on the basis of an output signal from the security check means, for the role signature which is to be assigned.

27. The data processing facility as claimed in claim 11, wherein the signature tool has access to a role signature memory and is adapted to check the role signature memory, on the basis of an output signal from the security check means, for the role signature which is to be assigned.

28. The data processing facility as claimed in claim 13, wherein the role signature memory is arranged remotely from the data processing facility, and wherein the signature tool has access thereto via a data telecommunication link.

29. A data processing facility, comprising:
security check means for, prior to the data processing facility accessing application data, performing a security check in order to ascertain an identity of a user; and
signature tool means for assigning a user signature identifying the user, on the basis of an output signal from the security check means without being viewable by the user, for assigning a role signature, assignable to a plurality of users, on the basis of an output signal from the security check means without being viewable by the user, and for signing access operations to electronic data by specifying the user signature and the role signature.

30. The data processing facility as claimed in claim 29, wherein the security check means is further for ascertaining biometric data from the user.

31. The data processing facility as claimed in claim 29, wherein the security check means is adapted to read at least one of electronic and mechanical keys.

32. The data processing facility as claimed in claim 29, wherein the signature tool means includes access to a user signature memory and is for checking the user signature memory, on the basis of an output signal from the security check means, for the user signature which is to be assigned.

33. The data processing facility as claimed in claim 29, wherein the signature tool includes access to a role signature memory and is for checking the role signature memory, on the basis of an output signal from the security check means, for the role signature which is to be assigned.

34. The data processing facility as claimed in claim 32, wherein the user signature memory is arranged remotely from the data processing facility, and wherein the signature tool has access thereto via a data telecommunication link.

35. The data processing facility as claimed in claim 32, wherein the role signature memory is arranged remotely from the data processing facility, and wherein the signature tool has access thereto via a data telecommunication link.

36. The data processing facility as claimed in claim 29, wherein the data processing facility is a medical workstation.
